(19) United States
(12) Patent Application Publication
(10) Pub. No.: US 2008/0205430 A1
(43) Pub. Date: Aug. 28, 2008

(54) BANDWIDTH CONTROL APPARATUS, BANDWIDTH CONTROL SYSTEM, AND BANDWIDTH CONTROL METHOD

(76) Inventor: Junichiro Matsui, Tokyo (JP)

Correspondence Address: NEC CORPORATION OF AMERICA, 6535 N. STATE HWY 161, IRVING, TX, 75039, US

(21) Appl. No.: 12/035,149

(22) Filed: Feb. 21, 2008

(30) Foreign Application Priority Data
Feb. 22, 2007 (JP) 42859/2007
Feb. 8, 2008 (JP) 29576/2008

(51) Int. Cl. H04L 12/413; H04L 12/56

(52) U.S. Cl. 370/445; 370/236; 709/233

(57) ABSTRACT

The present invention provides a bandwidth control system capable of controlling the transmission of data frames using a control frame including bandwidth information. A reception-side communication apparatus 21 transmits, to a transmission-side communication apparatus 20, a control frame including bandwidth information S213 for controlling the bandwidth of data frames transmitted from the transmission-side communication apparatus 20. When receiving the control frame including the bandwidth information S213, the transmission-side communication apparatus 20 controls the transmission of the data frames on the basis of the bandwidth information S213 included in the control frame.

This application is based upon and claims the benefit of priority from Japanese patent application No. 2007-042859, filed on Feb. 22, 2007, and No. 2008-029576, filed on Feb. 8, 2008, the disclosure of which is incorporated herein in its entirety by reference.

### BACKGROUND OF THE INVENTION

1. Field of the Invention

The present invention relates to a bandwidth control apparatus, a bandwidth control system, and a bandwidth control method capable of controlling data frames.

2. Description of the Related Art

In recent years, a CSMA/CD (Carrier Sense Multiple Access with Collision Detection) protocol defined by an IEEE802.3 standard has been used for networks. Hereinafter, examples of network structures using the CSMA/CD protocol defined by the IEEE802.3 standard will be described with reference to FIGS. 1 to 3.

FIGS. 1 to 3 are diagrams illustrating examples of the network structure using the CSMA/CD protocol defined by the IEEE802.3 standard.

In the network structure shown in FIG. 1, a transmission line 2 between a communication apparatus 1 and a communication apparatus 3 includes a bandwidth of 10 Gbps in the CSMA/CD protocol, and a transmission line 4 between the communication apparatus 3 and a communication apparatus 5 includes a bandwidth of 1 Gbps in the CSMA/CD protocol.

In the network structure shown in FIG. 1, the maximum bandwidth of data input to the communication apparatus 3 is 10 Gbps, but the maximum bandwidth of data that can be output from the communication apparatus 3 is 1 Gbps. Therefore, when data is output from the communication apparatus 1 in the data bandwidth of 1 Gbps or more for a long time, the communication apparatus 3 cannot output the data received from the communication apparatus 1 to the transmission line 4.

That is, the communication apparatus 3 is overloaded, and the communication apparatus 3 discards MAC (Media Access Control) frames.

In the network structure shown in FIG. 2, a transmission line 7 between a communication apparatus 6 and a communication apparatus 8 includes a bandwidth of 1 Gbps in the CSMA/CD protocol, and a transmission line 9 between the communication apparatus 8 and a communication apparatus 10 includes a bandwidth of 622.08 Mbps in SONET (Synchronous Optical NETwork) or SDH (Synchronous Digital Hierarchy) technology (STM-4 transmission line). The communication apparatus 8 performs a so-called Ethernet Over SONET/SDH process.

In the network structure shown in FIG. 2, similar to the network structure shown in FIG. 1, the communication apparatus 8 is likely to discard MAC frames.

In the network structure shown in FIG. 3, a transmission line 12 between a communication apparatus 11 and a communication apparatus 13, a transmission line 17 between a communication apparatus 16 and the communication apparatus 13, a transmission line 19 between a communication apparatus 18 and the communication apparatus 13, and a transmission line 14 between the communication apparatus 13 and a communication apparatus 15 all include a bandwidth of 1 Gbps in the CSMA/CD protocol.

In the network structure shown in FIG. 3, a maximum of 3 Gbps of MAC data is input to the communication apparatus 13 through three transmission lines. However, since the maximum bandwidth of data that can be output from the communication apparatus 13 is 1 Gbps, the communication apparatus 13 is likely to discard the MAC frames.

A control method shown in FIG. 4 has been proposed as an efficient way to prevent the overload of the communication apparatuses shown in FIGS. 1 to 3. In the CSMA/CD protocol defined by the IEEE802.3 standard, as shown in FIG. 4, a reception-side communication apparatus 21 can transmit, to a transmission-side communication apparatus 20, a ‘PAUSE frame’, which is a MAC control frame, to stop the transmission of the MAC frames from the transmission-side communication apparatus 20.

### Structure of PAUSE Frame

Next, the structure of the above-described ‘PAUSE frame’ will be described with reference to FIG. 5. FIG. 5 is a diagram illustrating the detailed structure of the ‘PAUSE frame’.

As shown in FIG. 5, the ‘PAUSE frame’ includes a ‘DA (Destination Address) field’, an ‘SA (Source Address) field’ a ‘Length/Type field’, an ‘Opcode field’, a ‘Pause Time field’, a ‘Padding field’, and an ‘FCS (Frame Check Sequence) field’.

An identification value for the PAUSE frame, for example, ‘01:80:C2:00:00:01’ is written in the ‘DA field’.

A ‘MAC address’ of a communication apparatus that transmits the PAUSE frame is written in the ‘SA field’.

A value ‘0x8808’ indicating a MAC control frame is written in the ‘Length/Type field’.

A value ‘0x0001’ indicating a PAUSE frame is written in the ‘Opcode field’.

A value ‘0-65535’, which is the time for which the communication apparatus receiving the PAUSE frame stops the transmission of data, is written in the ‘Pause Time field’.

The value written in the ‘Padding field’ is not particularly defined, but all octets in the ‘Padding field’ generally include a value of ‘0’.

A value indicating the ‘CRC (Cyclic Redundancy Check) result’ of a MAC frame is written in the ‘FCS field’.

### PAUSE Frame Control According to the Related Art

Next, a PAUSE frame control process according to the related art will be described with reference to FIG. 6. FIG. 6 is a diagram illustrating an example of the PAUSE frame control system according to the related art. In the following description, only a data transmission pause control process by ‘the reception of a PAUSE frame’ and ‘the transmission of a PAUSE frame’ will be described.

### PAUSE Frame Transmission Control

First, the operation of the reception-side communication apparatus 21 will be described in order to describe the transmission control of a PAUSE frame.

### MAC Frame Receiving Unit 211

A MAC frame receiving unit 211 includes a MAC frame storage memory 2111 and a storage data amount monitoring unit 2112. Storage data amount information S211 is transmitted from the MAC frame storage memory 2111 to the storage data amount monitoring unit 2112.

The storage data amount information S211 relates to the amount of data of the MAC frame stored in the MAC frame storage memory 2111.

The MAC frame receiving unit 211 stores the MAC frame received from a 10 Gbps transmission line 22 in the MAC frame storage memory 2111, and then outputs the MAC frame to a 1 Gbps transmission line 23.

As in the network structures shown in FIGS. 1 to 3, when the data bandwidth of an output side is smaller than that of an input side, the MAC frame is stored in the MAC frame storage memory 2111.

When receiving the storage data amount information S211, the storage data amount monitoring unit 2112 compares the amount of data stored in the MAC frame storage memory 2111 with a predetermined threshold value on the basis of the received storage data amount information S211. As the result of the comparison, when the amount of data stored in the MAC frame storage memory 2111 is larger than the predetermined threshold value, the storage data amount monitoring unit 2112 sets PAUSE transmission information S212 to ‘1’, and outputs the information to the MAC frame transmitting unit 212. On the other hand, when the amount of data stored in the MAC frame storage memory 2111 is not larger than the predetermined threshold value, the storage data amount monitoring unit 2112, sets the PAUSE transmission information S212 to ‘0’, and outputs the information to the MAC frame transmitting unit 212.

The predetermined threshold value may be set by a user setting terminal 26 connected to the reception-side communication apparatus 21. The PAUSE transmission information S212 is used to control a selector 2122, which will be described below, to output a ‘MAC data frame’ or a ‘PAUSE frame’ to a 10 Gbps transmission line 24.

### MAC Frame Transmitting Unit 212

The MAC frame transmitting unit 212 includes a PAUSE frame transmitting unit 2121 and the selector 2122.

When receiving the PAUSE transmission information S212 including value of ‘0’, the selector 2122 outputs the ‘MAC data frame’ transmitted from a 1 Gbps transmission line 25 to the 10 Gbps transmission line 24.

In addition, when receiving the PAUSE transmission information S212 including value of ‘1’, the selector 2122 outputs the ‘PAUSE frame’ transmitted from the PAUSE frame transmitting unit 2121 to the 10 Gbps transmission line 24.

### PAUSE Frame Reception Control

Next, the operation of the transmission-side communication apparatus 20 will be described in order to describe the data transmission pause control process by the PAUSE frame.

### MAC Frame Receiving Unit 202

A MAC frame receiving unit 202 includes a received data determining unit 2021.

The received data determining unit 2021 determines whether the MAC frame received by the MAC frame receiving unit 202 is a ‘PAUSE frame’ on the basis of the values written in the ‘DA field’ and the ‘Opcode field’ of the received MAC frame.

When it is determined that the received MAC frame is the ‘PAUSE frame’, the received data determining unit 2021 sets transmission pause information S204 to ‘1’, and outputs the information to the MAC frame transmitting unit 201. In addition, the received data determining unit 2021 outputs the value of the ‘Pause Time field’ to the MAC frame transmitting unit 201 as PAUSE information S203.

When it is determined that the received MAC frame is not the ‘PAUSE frame’, the received data determining unit 2021 sets the transmission pause information S204 to ‘0’, and outputs the information to the MAC frame transmitting unit 201. However, the received data determining unit 2021 outputs no PAUSE information S203.

### MAC Frame Transmitting Unit 201

The MAC frame transmitting unit 201 includes a transmission control unit 2011.

When the transmission pause information S204 received from the MAC frame receiving unit 202 has a value of ‘1’, the transmission control unit 2011 performs a data transmission pause control process. That is, the transmission control unit 2011 stops the transmission of the MAC frame for a time obtained by multiplying the value written in the ‘Pause Time field’ included in the PAUSE information S203 by a 512 bit time.

On the other hand, when the received transmission pause information S204 has a value of ‘0’, the transmission control unit 2011 outputs the MAC frame to the 10 Gbps transmission line 22 without performing the data transmission pause control process.

As described above, in the PAUSE frame control according to the related art shown in FIG. 6, the reception-side communication apparatus 21 transmits the ‘PAUSE frame’ to the transmission-side communication apparatus 20 according to the usage of memory resources of the MAC frame storage memory 2111. When receiving the PAUSE frame from the reception-side communication apparatus 21, the transmission-side communication apparatus 20 performs a control process of stopping the transmission of the MAC frame.

However, in the PAUSE frame control according to the related art, the transmission-side communication apparatus 20 determines whether to stop the transmission of the MAC frame on the basis of only the PAUSE frame. As a result, it is difficult to sufficiently utilize the transmission line 22.

Therefore, a control method capable of effectively utilizing the transmission line 22 needs to be developed.

As the prior art of the invention, a technique for controlling the bandwidth of server traffic in the unit (for example, an application or a destination IP address) set by a network administrator has been disclosed (for example, see Japanese Patent Application Laid-Open (JP-A) No. 2001-223714 (patent document 1)).

Further, a band limiting apparatus has been disclosed which uses only one switch including a block including an MII (Media Independent Interface) function to control a wide bandwidth including 10 Mbps or less (for example, see JP-A No. 2003-224575 (patent document 2)).

Furthermore, a technique for performing control so as not to exceed the allowable receiving rate of an opposite Ethernet (registered trademark) terminal has been disclosed (for example, see JP-A No. 2005-236423 (patent document 3)).

However, Patent Documents 1 to 3 do not disclose a technique for using a control frame including bandwidth information to control the transmission of data frames and the necessity therefor.

That is, it is difficult for the structures disclosed in Patent Documents 1 to 3 to improve the utilization of the transmission line 22.

### SUMMARY

The invention is designed to solve the above problems, and an exemplary object of the invention is to provide a bandwidth control apparatus, a bandwidth control system, and a bandwidth control method capable of controlling the transmission of data frames using a control frame including bandwidth information.

### Bandwidth Control Apparatus

According to an exemplary aspect of the invention, a bandwidth control apparatus includes a transmitting unit that transmits, to a communication apparatus, a control frame including bandwidth information for controlling the bandwidth of data frames transmitted from the communication apparatus.

According to another exemplary aspect of the invention, a bandwidth control apparatus includes a control unit that, when a control frame including bandwidth information is received, controls the transmission of data frames on the basis of the bandwidth information included in the control frame.

### Bandwidth Control System

According to yet another exemplary aspect of the invention, a bandwidth control system includes: a transmission-side communication apparatus that transmits data frames; and a reception-side communication apparatus that receives the data frames. The reception-side communication apparatus includes a transmitting unit that transmits, to the transmission-side communication apparatus, a control frame including bandwidth information for controlling the bandwidth of the data frames transmitted from the transmission-side communication apparatus. The transmission-side communication apparatus includes a control unit that, when the control frame including the bandwidth information is received, controls the transmission of the data frames on the basis of the bandwidth information included in the control frame.

### Bandwidth Control Method

According to yet still another exemplary aspect of the invention, there is provided a bandwidth control method that is performed in a bandwidth control system including a transmission-side communication apparatus that transmits data frames and a reception-side communication apparatus that receives the data frames. The method includes: a transmission step of allowing the reception-side communication apparatus to transmit, to the transmission-side communication apparatus, a control frame including bandwidth information for controlling the bandwidth of the data frames transmitted from the transmission-side communication apparatus; and a control step of allowing the transmission-side communication apparatus to, when the control frame including the bandwidth information is received, to control the transmission of the data frames on the basis of the bandwidth information included in the control frame.

According to still another exemplary aspect of the invention, there is provided a bandwidth control method that is performed in a bandwidth control apparatus that transmits a control frame to a communication apparatus. The method includes a transmission step of transmitting the control frame including bandwidth information for controlling the bandwidth of data frames transmitted from the communication apparatus.

### BRIEF DESCRIPTION OF THE DRAWINGS

FIG. 1 is a diagram illustrating a first network structure using a CSMA/CD protocol defined by an IEEE802.3 standard;

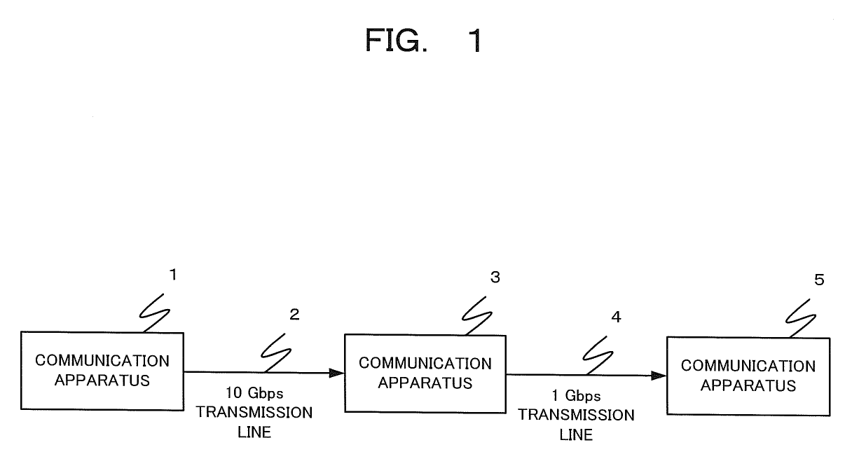

FIG. 2 is a diagram illustrating a second network structure using the CSMA/CD protocol defined by the IEEE802.3 standard;

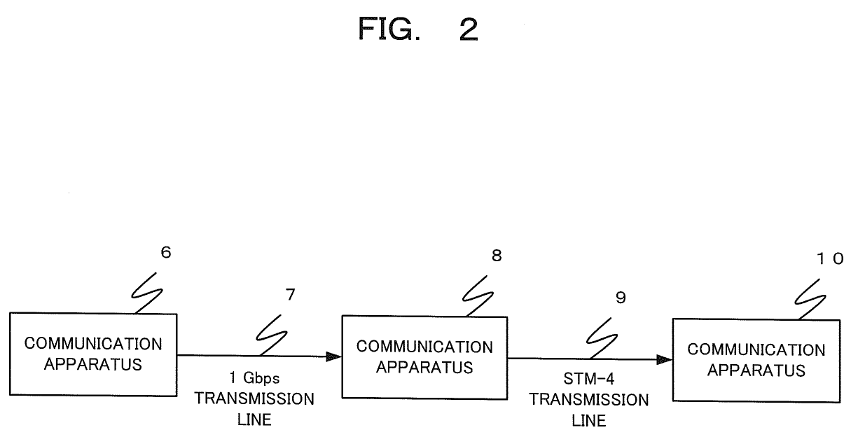

FIG. 3 is a diagram illustrating a third network structure using the CSMA/CD protocol defined by the IEEE802.3 standard;

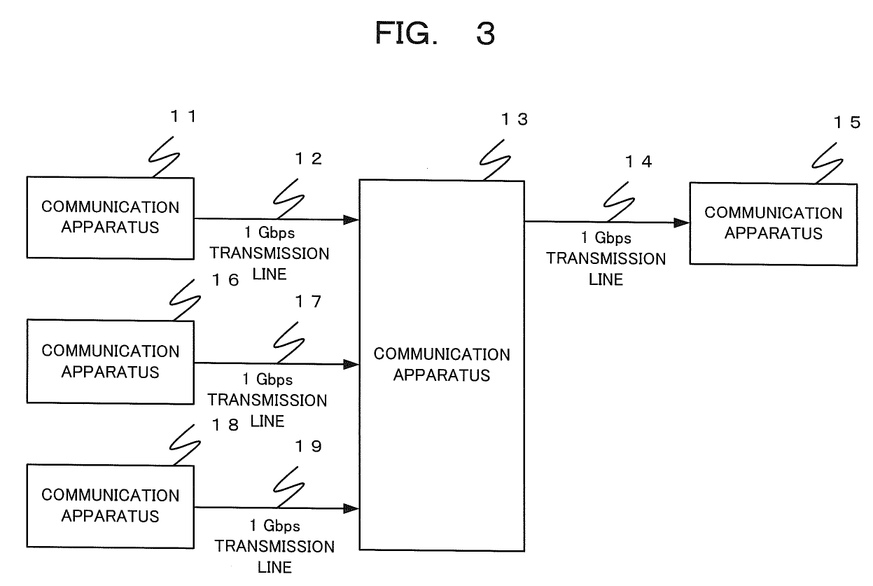

FIG. 4 is a diagram illustrating a PAUSE frame control process;

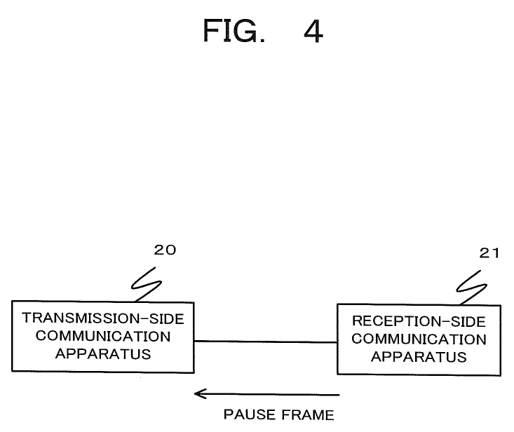

FIG. 5 is a diagram illustrating the detailed structure of a ‘PAUSE frame’;

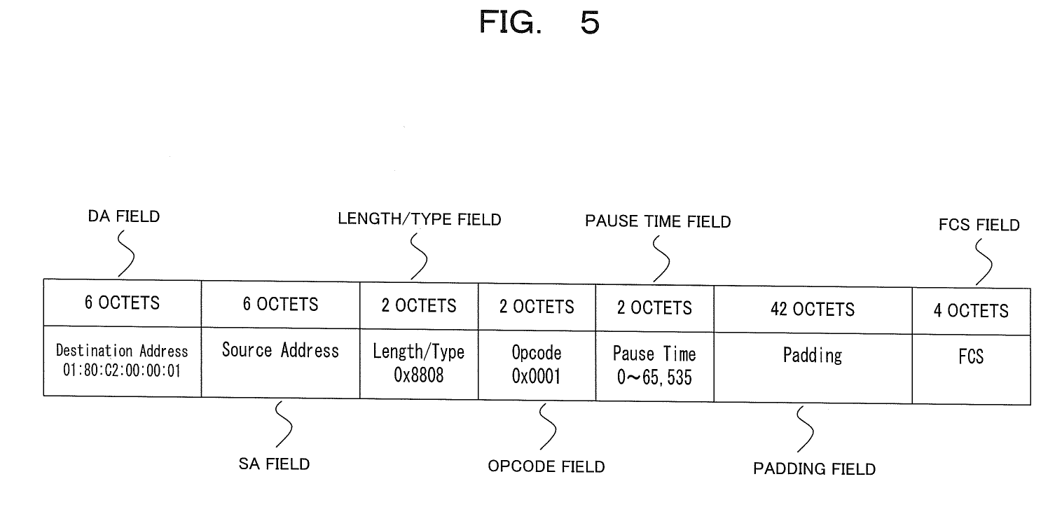

FIG. 6 is a diagram illustrating a bandwidth control system and a PAUSE frame control process according to the related art;

FIG. 7 is a diagram illustrating a bandwidth control system and a PAUSE frame control process according to an exemplary embodiment of the invention; and

FIG. 8 is a diagram illustrating the detailed structure of a ‘Padding field’ of a ‘PAUSE frame’ according to the exemplary embodiment of the invention.

### DESCRIPTION OF THE EXEMPLARY EMBODIMENTS

### Outline of Bandwidth Control System

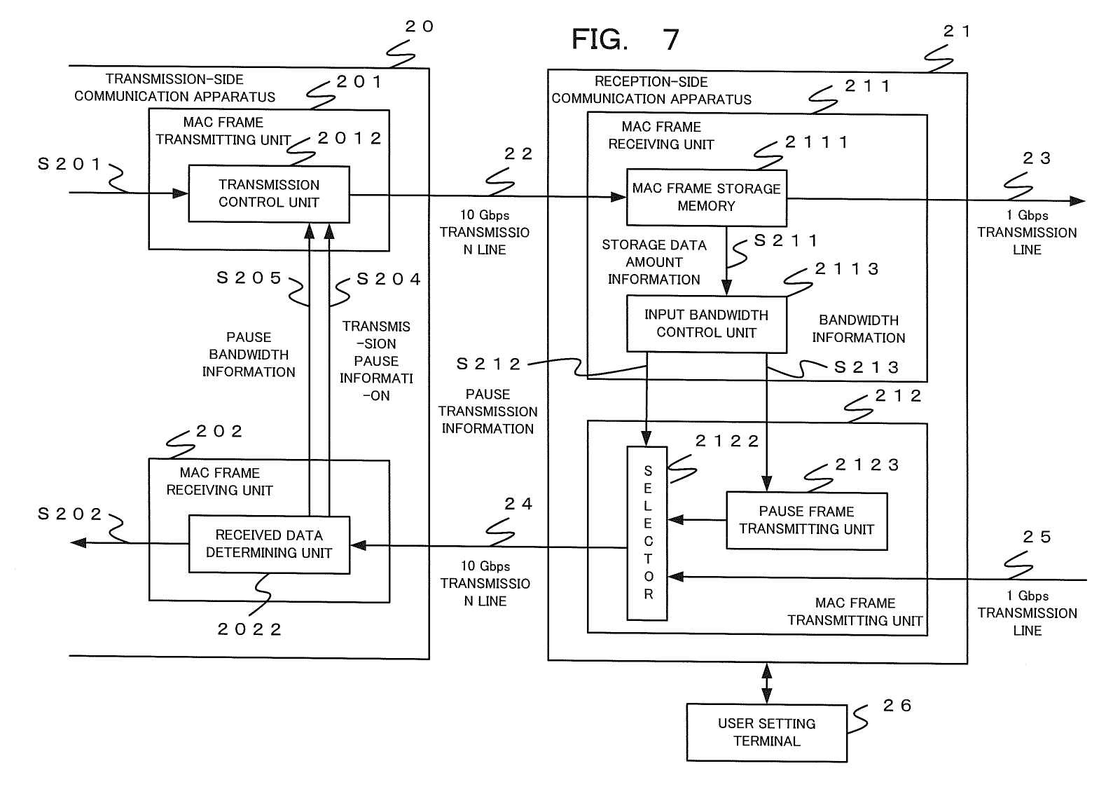

First, the outline of a bandwidth control system according to an exemplary embodiment of the invention will be described with reference to FIG. 7.

A bandwidth control system according to an exemplary embodiment of the invention includes: a transmission-side communication apparatus 20 that transmits data frames; and a reception-side communication apparatus 21 that receives the data frames. The reception-side communication apparatus 21 transmits, to the transmission-side communication apparatus 20, a control frame including bandwidth information S213 for controlling the bandwidth of the data frames transmitted from the transmission-side communication apparatus 20. When receiving the control frame including the bandwidth information S213, the transmission-side communication apparatus 20 controls the transmission of the data frames on the basis of the bandwidth information S213 included in the control frame. In this way, the bandwidth control system according to the exemplary embodiment can control the transmission of data frames to a transmission line 22 on the basis of the control frame including the bandwidth information S213. As a result, it is possible to effectively utilize the transmission line 22. Next, the bandwidth control system according to the exemplary embodiment will be described in detail with reference to the accompanying drawings.

### First Exemplary Embodiment

### Structure of Bandwidth Control System

First, the structure of a bandwidth control system according to a first exemplary embodiment of the invention will be described with reference to FIG. 7. FIG. 7 is a diagram illustrating an example of the structure of the bandwidth control system according to the exemplary embodiment.

The bandwidth control system according to the exemplary embodiment includes a transmission-side communication apparatus 20 and a reception-side communication apparatus 21.

### Structure of Transmission-Side Communication Apparatus 20

The transmission-side communication apparatus 20 includes a MAC frame transmitting unit 201 and a MAC frame receiving unit 202.

The MAC frame transmitting unit 201 includes a transmission control unit 2012. In addition, the MAC frame receiving unit 202 includes a received data determining unit 2022. <Structure of reception-side communication apparatus 21>The reception-side communication apparatus 21 includes a MAC frame receiving unit 211 and a MAC frame transmitting unit 212.

The MAC frame receiving unit 211 includes a MAC frame storage memory 2111 and an input bandwidth control unit 2113. The MAC frame transmitting unit 212 includes a selector 2122 and a PAUSE frame transmitting unit 2123.

The input bandwidth control unit 2113 of the reception-side communication apparatus 21 according to the exemplary embodiment outputs, to the PAUSE frame transmitting unit 2123, bandwidth information S213 for controlling the bandwidth of MAC frames transmitted from the transmission-side communication apparatus 20. The bandwidth information S213 may be set by a user setting terminal 26 that is connected to the reception-side communication apparatus 21, and set the bandwidth of data frames that can be received by the reception-side communication apparatus 21. For example, in the structure of the system shown in FIG. 7, it is preferable that the bandwidth of the MAC frames transmitted from the transmission-side communication apparatus 20 be set to 1 Gbps that is equal to the bandwidth of a transmission line 23.

The PAUSE frame transmitting unit 2123 stores the bandwidth information S213 output from the input bandwidth control unit 2113 in a ‘Padding field’ of a ‘PAUSE frame’, and transmits the ‘PAUSE frame’ including the bandwidth information S213 stored therein to the transmission-side communication apparatus 20.

When the MAC frame received from the reception-side communication apparatus 21 is the ‘PAUSE frame’ including the bandwidth information S213, the received data determining unit 2022 of the transmission-side communication apparatus 20 outputs PAUSE bandwidth information S205 including the bandwidth information S213 to the transmission control unit 2012.

The transmission control unit 2012 controls the bandwidth of the MAC frame transmitted to the transmission line 22 on the basis of the bandwidth information S213 included in the PAUSE bandwidth information S205 output from the received data determining unit 2022.

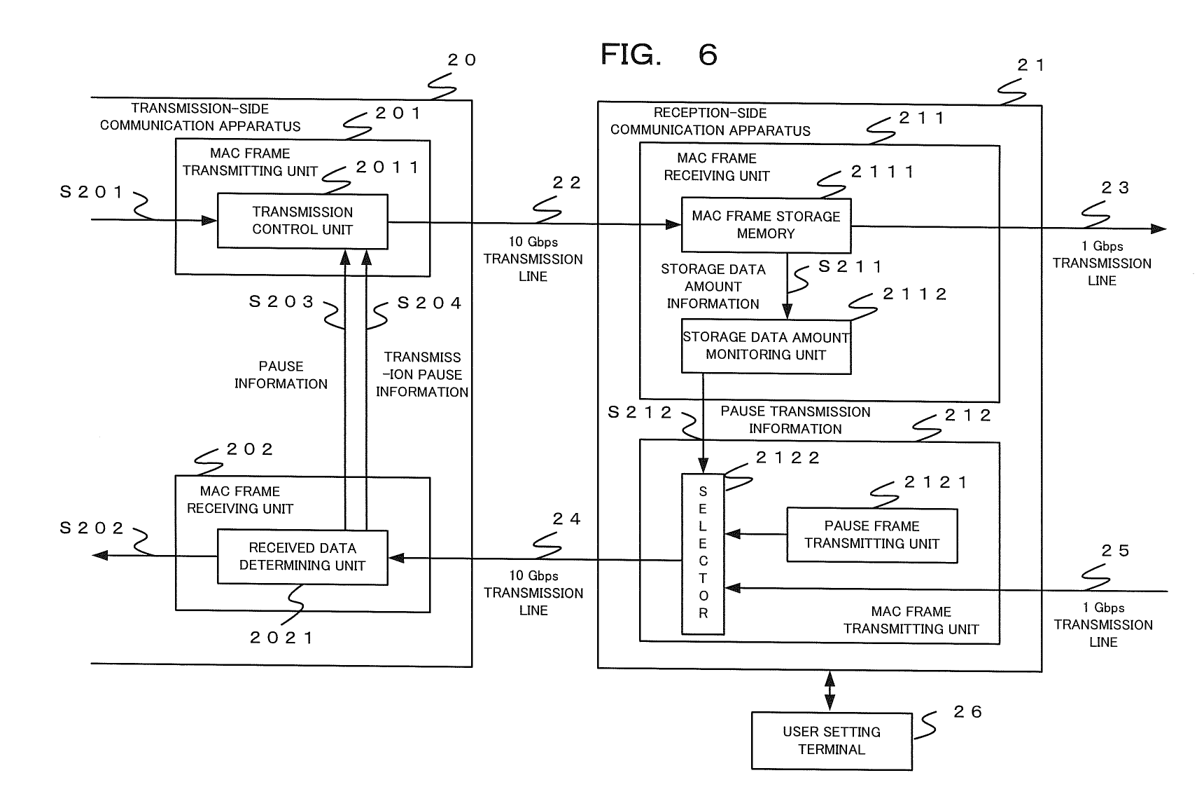

In the bandwidth control system including the above-described functions, the reception-side communication apparatus 21 transmits, to the transmission-side communication apparatus 20, the ‘PAUSE frame’ including the bandwidth information S213 for controlling the bandwidth of the MAC frame transmitted from the transmission-side communication apparatus 20. When receiving the ‘PAUSE frame’ including the bandwidth information S213, the transmission-side communication apparatus 20 controls the bandwidth of the MAC frames transmitted to the transmission line 22, on the basis of the bandwidth information S213. In this way, the transmission-side communication apparatus 20 can control the bandwidth of the MAC frames transmitted to the transmission line 22 on the basis of the bandwidth information S213 included in the ‘PAUSE frame’. Therefore, it is possible to utilize the transmission line 22 more effectively than the PAUSE frame control process according to the related art shown in FIG. 6.

### Detailed Structure of Padding Field

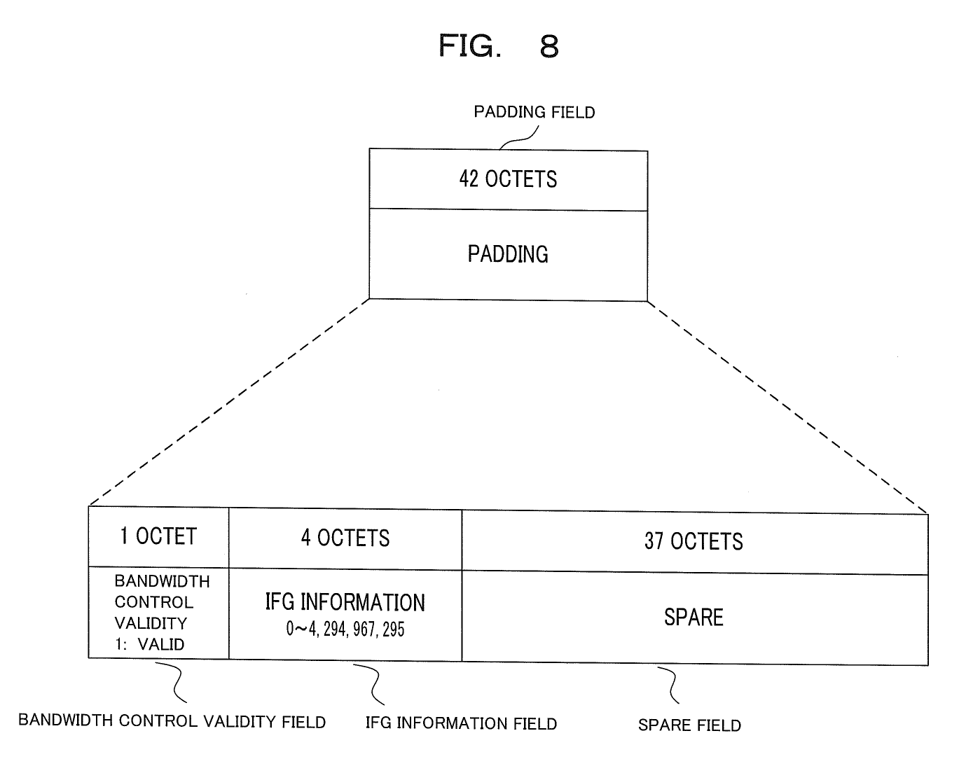

Next, the detailed structure of the ‘Padding field’ included in the ‘PAUSE frame’ of the exemplary embodiment will be described with reference to FIG. 8. FIG. 8 is a diagram illustrating an example of the bandwidth information S213 stored in the ‘Padding field’.

As show in FIG. 8, the ‘Padding field’ includes a ‘bandwidth control validity field’, an ‘IFG information field’, and a ‘spare field’.

### Bandwidth Control Validity Field

When a value of ‘1’ is written in the ‘bandwidth control validity field’, bandwidth control according to the exemplary embodiment is valid. When a value of ‘0’ is written in the ‘bandwidth control validity field’, the bandwidth control according to the exemplary embodiment is invalid, that is, the PAUSE frame control according to the related art shown in FIG. 6 is performed. The value ‘0’ or ‘1’, which is information written in the ‘bandwidth control validity field’, can be set by the user setting terminal 26.

### IFG Information Field

For example, when a value of ‘0’ is written in the ‘IFG information field’, MAC data frames are transmitted with an IFG (Inter-Frame Gap) of 20 bites. When a value of ‘10’ is written in the ‘IFG information field’, MAC data frames are transmitted with an IFG of 30 bites. The IFG is information indicating the gap at which the transmission-side communication apparatus 20 transmits the MAC data frames. The IFG information stored in the ‘IFG information field’ can be set by the user setting terminal 26.

### Spare Field

The ‘spare field’ is provided to store other information items.

### PAUSE Frame Control According to the Exemplary Embodiment

Next, PAUSE frame control according to the exemplary embodiment will be described with reference to FIG. 7. FIG. 7 is a diagram illustrating an example of the PAUSE frame control according to the exemplary embodiment.

### Input Bandwidth Control Unit 2113

When receiving storage data amount information S211 transmitted from the MAC frame storage memory 2111, the input bandwidth control unit 2113 compares the amount of data stored in the MAC frame storage memory 2111 with a predetermined threshold value, on the basis of the received storage data amount information S211. When the amount of data stored in the MAC frame storage memory 2111 is larger than the predetermined threshold value, the input bandwidth control unit 2113 sets PAUSE transmission information S212 to ‘1’, and outputs the information to the selector 2122. The predetermined threshold value may be set by the user setting terminal 26 that is connected to the reception-side communication apparatus 21.

When the amount of data stored in the MAC frame storage memory 2111 is equal to or smaller than the predetermined threshold value, the input bandwidth control unit 2113 sets the PAUSE transmission information S212 to ‘0’, and outputs the information to the selector 2122.

When the bandwidth control according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ including IFG information stored therein, which are shown in FIG. 8.

When the bandwidth control according to the exemplary embodiment is set to be invalid, the input bandwidth control unit 2113 outputs, to the PAUSE frame transmitting unit 2123, the bandwidth information S213 including the ‘bandwidth control validity field’ including a value ‘0’ written therein, which is shown in FIG. 8.

### PAUSE Frame Transmitting Unit 2123

when the bandwidth information S213 is input from the input bandwidth control unit 2113, the PAUSE frame transmitting unit 2123 determines whether the value written in the ‘bandwidth control validity field’ is ‘1’, which indicates validity, or ‘0’, which indicates invalidity, on the basis of the bandwidth information S213.

When it is determined that the value written in the ‘bandwidth control validity field’ is ‘1’, which indicates validity, the PAUSE frame transmitting unit 2123 stores the bandwidth information S213 in the ‘Padding field’ of the ‘PAUSE frame’, and outputs a ‘PAUSE frame’ including a ‘Pause Time field’ set to ‘0’ to the selector 2122.

In this way, the PAUSE frame transmitting unit 2123 can output, to the selector 2122, the ‘PAUSE frame’ including information of the ‘Padding field’ shown in FIG. 8 and the ‘Pause Time field’ including a value of ‘0’ written therein.

When the value written in the ‘bandwidth control validity field’ is ‘0’, which indicates invalidity, the PAUSE frame transmitting unit 2123 outputs, to the selector 2122, the ‘PAUSE frame’ according to the related art shown in FIG. 6.

### Selector 2122

When receiving the PAUSE transmission information S212 including a value of ‘0’ that is transmitted from the input bandwidth control unit 2113, the selector 2122 outputs the ‘MAC data frame’ transmitted from a 1 Gbps transmission line 25 to a 10 Gbps transmission line 24.

When receiving the PAUSE transmission information S212 including a value of ‘1’, the selector 2122 outputs the ‘PAUSE frame’ transmitted from the PAUSE frame transmitting unit 2123 to the 10 Gbps transmission line 24.

Further, the reception-side communication apparatus 21 according to the exemplary embodiment transmits only one ‘PAUSE frame including the bandwidth information S213 stored therein’ to the transmission-side communication apparatus 20. Therefore, the input bandwidth control unit 2113 controls the PAUSE transmission information S212 output to the selector 2122, and controls the selector 2122 to output only one ‘PAUSE frame including the bandwidth information S213 stored therein’.

That is, in the exemplary embodiment, when controlling the bandwidth of the MAC frame transmitted from the transmission-side communication apparatus 20, the input bandwidth control unit 2113 sets the PAUSE transmission information S212 to ‘1’, and outputs the information. to the selector 2122, regardless of whether the amount of data stored in the MAC frame storage memory 2111 is larger than the predetermined threshold value. In addition, the input bandwidth control unit 2113 outputs, to the PAUSE frame transmitting unit 2123, the bandwidth information S213 including the ‘bandwidth control validity field’ including a value of ‘1’ written therein and the ‘IFG information field’ including IFG information stored therein. In this way, the reception-side communication apparatus 21 can transmit only one ‘PAUSE frame including the bandwidth information S213 stored therein’ to the transmission-side communication apparatus 20.

Only one ‘PAUSE frame including the bandwidth information S213 stored therein’ is transmitted under the following conditions: when a PAUSE frame transmission request is received from the user setting terminal 26; when there is a change in the bandwidth information S213 set by the user setting terminal 26; when an Ethernet link between the transmission-side communication apparatus 20 and the reception-side communication apparatus 21 is reestablished from a disconnected state; and when the bandwidth of the transmission line 23 through which the reception-side communication apparatus 21 can transmit data is smaller than that of the transmission line 22 through which the reception-side communication apparatus 21 receives data.

Furthermore, the reception-side communication apparatus 21 can monitor the transmission lines 22 and 23 to check the data bandwidths of the transmission lines 22 and 23.

### Received Data Determining Unit 2022

The received data determining unit 2022 determines whether the MAC frame received by the MAC frame receiving unit 202 is a ‘data frame’, the ‘PAUSE frame according to the related art’, or the ‘PAUSE frame including the bandwidth information S213 stored therein’ on the basis of a ‘DA field’, a ‘Length/Type field’, an ‘Opcode field’, and the ‘bandwidth control validity field’ of the ‘Padding field’ in the MAC frame. The term ‘PAUSE frame according to the related art’ means the PAUSE frame described with reference to FIG. 6.

When it is determined that the received MAC frame is the ‘data frame’, the received data determining unit 2022 forwards the data frame to the next processing unit (not shown) through S202. In addition, the received data determining unit 2022 sets transmission pause information S204 to ‘0’, and outputs the information to the MAC frame transmitting unit 201. However, the received data determining unit 2022 outputs no PAUSE bandwidth information S205.

Further, when it is determined that the received MAC frame is the ‘PAUSE frame according to the related art’, the received data determining unit 2022 performs the control process shown in FIG. 6.

That is, when it is determined that the received MAC frame is the ‘PAUSE frame according to the related art’, the received data determining unit 2022 sets the transmission pause information S204 to ‘1’, and outputs the information to the MAC frame transmitting unit 201. In addition, the received data determining unit 2022 outputs the value written in the ‘Pause Time field’ of the ‘PAUSE frame according to the related art’ to the MAC frame transmitting unit 201 as the PAUSE bandwidth information S205.

When it is determined that the received MAC frame is the ‘PAUSE frame including the bandwidth information S213 stored therein’, the received data determining unit 2022 sets the transmission pause information S204 to ‘1’, and outputs the information to the MAC frame transmitting unit 201. In addition, the received data determining unit 2022 outputs a value of ‘0’ written in the ‘Pause Time field’ of the ‘PAUSE frame including the bandwidth information S213 stored therein’ and the bandwidth information S213 to the MAC frame transmitting unit 201 as the PAUSE bandwidth information S205.

### Transmission Control Unit 2012

The transmission control unit 2012 determines whether to perform the PAUSE control process according to the related art shown in FIG. 6 or the bandwidth control process according to the exemplary embodiment, on the basis of the transmission pause information S204 and the PAUSE bandwidth information S205 received from the MAC frame receiving unit 202.

First, when the transmission pause information S204 includes a value of ‘0’, the transmission control unit 2012 outputs the MAC frame to the 10 Gbps transmission line 22 without performing a data transmission pause control process.

When the transmission pause information S204 including a value of ‘1’ is received from the MAC frame receiving unit 202, the transmission control unit 2012 checks the PAUSE bandwidth information S205. As the check result, when the bandwidth information S213 is not included in the PAUSE bandwidth information S205, the transmission control unit 2012 performs the data transmission pause control process according to the related art shown in FIG. 6. In this case, the transmission control unit 2012 stops the transmission of the MAC frame for a time that is obtained by multiplying the value written in the ‘Pause Time field’ included in the PAUSE bandwidth information S205 by a 512 bit time.

Further, when the bandwidth information S213 is included in the PAUSE bandwidth information S205, the transmission control unit 2012 performs the data bandwidth control process according to the exemplary embodiment. In this case, the transmission control unit 2012 controls the transmission interval of the MAC frames, on the basis of the value written in the ‘IFG information field’ in the ‘Padding field’ included in the PAUSE bandwidth information S205, and also controls the bandwidth of the MAC frame transmitted to the 10 Gbps transmission line 22.

In the bandwidth control system according to the exemplary embodiment, when performing the bandwidth control process according to the exemplary embodiment, the reception-side communication apparatus 21 transmits, to the transmission-side communication apparatus 20, the ‘PAUSE frame’ including the bandwidth information S213 for controlling the bandwidth of the MAC frame transmitted by the transmission-side communication apparatus 20. Then, the transmission-side communication apparatus 20 controls the bandwidth of the MAC frame transmitted to the transmission line 22, on the basis of the bandwidth information S213 included in the ‘PAUSE frame’ received from the reception-side communication apparatus 21. In this way, the bandwidth control system according to the exemplary embodiment can improve the utilization of the transmission line 22, unlike the PAUSE frame control system according to the related art shown in FIG. 6.

### Second Exemplary Embodiment

Next, a second exemplary embodiment of the invention will be described.

In the first exemplary embodiment, during the bandwidth control process, the input bandwidth control unit 2113 transmits, to the transmission-side communication apparatus 20, the PAUSE frame including the bandwidth information S213 for controlling the bandwidth of the MAC frame transmitted by the transmission-side communication apparatus 20, regardless of whether the amount of data stored in the MAC frame storage memory 2111 is larger than a predetermined threshold value.

In the second exemplary embodiment, the input bandwidth control unit 2113 transmits, to the transmission-side communication apparatus 20, the PAUSE frame including the bandwidth information S213 for controlling the bandwidth of the MAC frame transmitted by the transmission-side communication apparatus 20, when the amount of data stored in the MAC frame storage memory 2111 is larger than a predetermined threshold value. However, when the amount of data stored in the MAC frame storage memory 2111 is not larger than the predetermined threshold value, the input bandwidth control unit 2113 transmits a PAUSE frame including the bandwidth information S213 including a value of ‘0’ to the transmission-side communication apparatus 20.

In this way, the bandwidth control system according to the exemplary embodiment can control the bandwidth of the MAC frame transmitted from the transmission-side communication apparatus 20 according to the empty state of memory resources of the MAC frame storage memory 2111 in the reception-side communication apparatus. The second exemplary embodiment will be described in detail below.

### Structure of Bandwidth Control System

First, the structure of the bandwidth control system according to the exemplary embodiment will be described with reference to FIG. 7.

The structure of the bandwidth control system according to the second exemplary embodiment is similar to that according to the first exemplary embodiment except for the control operation of the input bandwidth control unit 2113 in the reception-side communication apparatus 21. The control operation of the input bandwidth control unit 2113 will be described in detail below.

### Input Bandwidth Control Unit 2113

In the second exemplary embodiment, when receiving storage data amount information S211 transmitted from the MAC frame storage memory 2111, the input bandwidth control unit 2113 compares the amount of data stored in the MAC frame storage memory 2111 with a predetermined threshold value, on the basis of the received storage data amount information S211. When the amount of data stored in the MAC frame storage memory 2111 is larger than the predetermined threshold value, the input bandwidth control unit 2113 determines whether a bandwidth control process according to the exemplary embodiment is set to be valid or invalid. When it is determined that the bandwidth control process according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ including IFG information set by the user setting terminal 26 stored therein, which are shown in FIG. 8.

In this way, when it is determined that the amount of data stored in the MAC frame storage memory 2111 is larger than the predetermined threshold value and the bandwidth control process according to the exemplary embodiment is set to be valid, the input bandwidth control unit 2113 can control the bandwidth of the MAC frame transmitted from the transmission-side communication apparatus 20.

Further, when it is determined that the amount of data stored in the MAC frame storage memory 2111 is larger than the predetermined threshold value and the bandwidth control process according to the exemplary embodiment is set to be invalid, the input bandwidth control unit 2113 outputs, to the PAUSE frame transmitting unit 2123, the bandwidth information S213 including the ‘bandwidth control validity field’ including a value ‘0’ written therein, which is shown in FIG. 8.

In this way, when it is determined that the amount of data stored in the MAC frame storage memory 2111 is larger than the predetermined threshold value and the bandwidth control process according to the exemplary embodiment is set to be invalid, the input bandwidth control unit 2113 can perform the bandwidth control process according to the related art shown in FIG. 6.

Furthermore, when it is determined that the amount of data stored in the MAC frame storage memory 2111 is not larger than the predetermined threshold value and the bandwidth control process according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ in which IFG information including a value of 0 is written, which are shown in FIG. 8.

In this way, when it is determined that the amount of data stored in the MAC frame storage memory 2111 is not larger than the predetermined threshold value and the bandwidth control process according to the exemplary embodiment is set to be valid, the input bandwidth control unit 2113 can remove the limitations in the bandwidth of the MAC frame transmitted from the transmission-side communication apparatus 20.

Further, in the exemplary embodiment, the input bandwidth control unit 2113 controls the PAUSE transmission information S212 output to the selector 2122, and controls the selector 2122 to transmit only one ‘PAUSE frame’ including the bandwidth information S213 including the ‘IFG information field’ in which IFG information including a value of ‘0’ is written.

That is, in the exemplary embodiment, the input bandwidth control unit 2113 controls the selector 2122 to transmit the ‘PAUSE frame’ including the bandwidth information S213 including the ‘IFG information field’ in which IFG information including a value of ‘0’ is written. Therefore, when it is determined that the amount of data stored in the MAC frame storage memory 2111 is not larger than the predetermined threshold value once, the input bandwidth control unit 2113 outputs the PAUSE transmission information S212 including a value of ‘1’ to the selector 2122, and controls the selector 2122 to transmit the ‘PAUSE frame’ including the bandwidth information S213 including the ‘IFG information field’ in which IFG information including a value of ‘O’ is written.

When it is determined that the amount of data stored in the MAC frame storage memory 2111 is not larger than the predetermined threshold value two or more times, the input bandwidth control unit 2113 outputs the PAUSE transmission information S212 including a value of ‘0’ to the selector 2122, and controls the selector 2122 to transmit the ‘MAC data frame’.

As described above, in the exemplary embodiment, the reception-side communication apparatus 21 can control the bandwidth of the MAC frame transmitted from the transmission-side communication apparatus 20 according to the empty state of memory resources of the MAC frame storage memory 2111 in the reception-side communication apparatus 21.

### Third Exemplary Embodiment

Next, a third exemplary embodiment of the invention will be described.

In a bandwidth control system according to the third exemplary embodiment, the reception-side communication apparatus 21 transmits, to the transmission-side communication apparatus 20, a control frame including bandwidth information S213 that can be received by the reception-side communication apparatus 21. Then, the transmission-side communication apparatus 20 controls the transmission of data frames on the basis of the bandwidth information S213 included in the control frame.

In this way, the bandwidth control system according to the exemplary embodiment can control the data frames transmitted from the transmission-side communication apparatus 20 on the basis of the control frame including the bandwidth information S213. As a result, it is possible to prevent the overload of the reception-side communication apparatus 21 without increasing memory resources of the MAC frame storage memory 2111 in the reception-side communication apparatus 21. Hereinafter, the bandwidth control system according to the exemplary embodiment will be described in detail with reference to the accompanying drawings.

### Structure of Bandwidth Control System

First, the structure of the bandwidth control system according to the third exemplary embodiment of the invention will be described with reference to FIG. 7. FIG. 7 is a diagram illustrating an example of the structure of the bandwidth control system according to the exemplary embodiment.

The bandwidth control system according to the exemplary embodiment includes a transmission-side communication apparatus 20 and a reception-side communication apparatus 21.

### Structure of Transmission-Side Communication Apparatus 20

The transmission-side communication apparatus 20 includes a MAC frame transmitting unit 201 and a MAC frame receiving unit 202.

The MAC frame transmitting unit 201 includes a transmission control unit 2012. In addition, the MAC frame receiving unit 202 includes a received data determining unit 2022. <Structure of reception-side communication apparatus 21>The reception-side communication apparatus 21 includes a MAC frame receiving unit 211 and a MAC frame transmitting unit 212.

The MAC frame receiving unit 211 includes a MAC frame storage memory 2111 and an input bandwidth control unit 2113. The MAC frame transmitting unit 212 includes a selector 2122 and a PAUSE frame transmitting unit 2123.

The bandwidth control system according to the exemplary embodiment differs from the bandwidth control system shown in FIG. 6 in that the control operations of the input bandwidth control unit 2113 and the PAUSE frame transmitting unit 2123 in the reception-side communication apparatus 21 and the control operations of the received data determining unit 2022 and the transmission control unit 2012 in the transmission-side communication apparatus 20.

That is, in the embodiment, the input bandwidth control unit 2113 of the reception-side communication apparatus 21 has a function of outputting the bandwidth information S213 that can be received by the reception-side communication apparatus 21 to the PAUSE frame transmitting unit 2123, in addition to the function of the storage data amount monitoring unit 2112 shown in FIG. 6. The bandwidth information S213 may be set by the user setting terminal 26 connected to the reception-side communication apparatus 21.

The PAUSE frame transmitting unit 2123 stores the bandwidth information S213 output from the input bandwidth control unit 2113 in a ‘Padding field’ of a ‘PAUSE frame’, and transmits the ‘PAUSE frame’ including the bandwidth information S213 stored therein to the transmission-side communication apparatus 20.

When the MAC frame received from the reception-side communication apparatus 21 is the ‘PAUSE frame’ including the bandwidth information S213, the received data determining unit 2022 of the transmission-side communication apparatus 20 transmits the bandwidth information S213 to the transmission control unit 2012.

The transmission control unit 2012 controls the transmission of the MAC frame on the basis of the bandwidth information S213 transmitted from the received data determining unit 2022.

In the bandwidth control system including the above-described functions according to the embodiment, the reception-side communication apparatus 21 transmits, to the transmission-side communication apparatus 20, the ‘PAUSE frame’ including the bandwidth information S213 that can be received by the reception-side communication apparatus 21. When receiving the ‘PAUSE frame’ including the bandwidth information S213, the transmission-side communication apparatus 20 controls the transmission of MAC frames to the reception-side communication apparatus 21 on the basis of the received bandwidth information S213. In this way, the transmission-side communication apparatus 20 can control the MAC frames transmitted to a 10 Gbps transmission line 22. As a result, it is possible to prevent the overload of the reception-side communication apparatus 21.

### Detailed Structure of Padding Field

Next, the detailed structure of the ‘Padding field’ included in the ‘PAUSE frame’ of the embodiment will be described with reference to FIG. 8. FIG. 8 is a diagram illustrating an example of the bandwidth information S213 stored in the ‘Padding field’.

As show in FIG. 8, the ‘Padding field’ includes a ‘bandwidth control validity field’, an ‘IFG information field’, and a ‘spare field’.

### Bandwidth Control Validity Field

When a value of ‘1’ is written in the ‘bandwidth control validity field’, bandwidth control according to the exemplary embodiment is valid. When a value of ‘0’ is written in the ‘bandwidth control validity field’, the bandwidth control according to the exemplary embodiment is invalid, that is, the ‘PAUSE frame’ control shown in FIG. 6 is performed. The value ‘0’ or ‘1’, which is information written in the ‘bandwidth control validity field’, can be set by the user setting terminal 26.

### IFG Information Field

For example, when a value of ‘0’ is written in the ‘IFG information field’, MAC data frames are transmitted with an IFG (Inter-Frame Gap) of 20 bites. When a value of ‘10’ is written in the ‘IFG information field’, MAC data frames are transmitted with an IFG of 30 bites. The IFG is information indicating the gap at which the transmission-side communication apparatus 20 transmits the MAC data frames. The IFG information stored in the ‘IFG information field’ can be set by the user setting terminal 26.

### Spare Field

The ‘spare field’ is provided to store other information items.

### PAUSE Frame Control according to the Exemplary Embodiment

Next, PAUSE frame control according to the exemplary embodiment will be described with reference to FIG. 7. FIG. 7 is a diagram illustrating an example of the PAUSE frame control according to the exemplary embodiment.

### Input Bandwidth Control Unit 2113

When receiving storage data amount information S211 transmitted from the MAC frame storage memory 2111, the input bandwidth control unit 2113 compares the amount of data stored in the MAC frame storage memory 2111 with a predetermined threshold value, on the basis of the received storage data amount information S211. When the amount of data stored in the MAC frame storage memory 2111 is larger than the predetermined threshold value, the input bandwidth control unit 2113 sets PAUSE transmission information S212 to ‘1’, and outputs the information to the selector 2122. The predetermined threshold value may be set by the user setting terminal 26 that is connected to the reception-side communication apparatus 21.

When the amount of data stored in the MAC frame storage memory 2111 is equal to or smaller than the predetermined threshold value, the input bandwidth control unit 2113 sets the PAUSE transmission information S212 to ‘0’, and outputs the information to the selector 2122.

When the bandwidth control according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ including IFG information set by the user setting terminal 26 stored therein, which are shown in FIG. 8.

When the bandwidth control according to the exemplary embodiment is set to be invalid, the input bandwidth control unit 2113 outputs, to the PAUSE frame transmitting unit 2123, the bandwidth information S213 including the ‘bandwidth control validity field’ including a value ‘0’ written therein, which is shown in FIG. 8. The user setting terminal 26 may set whether the bandwidth control according to the exemplary embodiment is valid or invalid.

### PAUSE Frame Transmitting Unit 2123

When the bandwidth information S213 is input from the input bandwidth control unit 2113, the PAUSE frame transmitting unit 2123 determines whether the value written in the ‘bandwidth control validity field’ is ‘1’, which indicates validity, or ‘0’, which indicates invalidity, on the basis of the bandwidth information S213.

When it is determined that the value written in the ‘bandwidth control validity field’ is ‘1’, which indicates validity, the PAUSE frame transmitting unit 2123 stores the bandwidth information S213 in the ‘Padding field’ of the ‘PAUSE frame’, and outputs a ‘PAUSE frame’ including a ‘Pause Time field’ set to ‘0’ to the selector 2122.

In this way, the PAUSE frame transmitting unit 2123 can output, to the selector 2122, the ‘PAUSE frame’ including information of the ‘Padding field’ shown in FIG. 8 and the ‘Pause Time field’ including a value of ‘0’ written therein.

When the value written in the ‘bandwidth control validity field’ is ‘0’, which indicates invalidity, the PAUSE frame transmitting unit 2123 outputs, to the selector 2122, the ‘PAUSE frame’ according to the related art shown in FIG. 6.

### Selector 2122

When receiving the PAUSE transmission information S212 including a value of ‘0’ that is transmitted from the input bandwidth control unit 2113, the selector 2122 outputs the ‘MAC data frame’ transmitted from a 1 Gbps transmission line 25 to a 10 Gbps transmission line 24.

When receiving the PAUSE transmission information S212 including a value of ‘1’, the selector 2122 outputs the ‘PAUSE frame’ transmitted from the PAUSE frame transmitting unit 2123 to the 10 Gbps transmission line 24.

Further, the reception-side communication apparatus 21 according to the exemplary embodiment transmits only one ‘PAUSE frame including the bandwidth information S213 stored therein’ to the transmission-side communication apparatus 20. Therefore, the input bandwidth control unit 2113 controls the PAUSE transmission information S212 output to the selector 2122, and controls the selector 2122 to transmit only one ‘PAUSE frame including the bandwidth information S213 stored therein’.

That is, in the exemplary embodiment, during the bandwidth control, the input bandwidth control unit 2113 sets the PAUSE transmission information S212 to ‘1’, and outputs the information to the selector 2122, regardless of whether the amount of data stored in the MAC frame storage memory 2111 is larger than the predetermined threshold value. In addition, the input bandwidth control unit 2113 outputs, to the PAUSE frame transmitting unit 2123, the bandwidth information S213 including the ‘bandwidth control validity field’ including a value of ‘1’ and the ‘IFG information field’ including the IFG information stored therein. In this way, the reception-side communication apparatus 21 can transmit only one ‘PAUSE frame including the bandwidth information S213 stored therein’ to the transmission-side communication apparatus 20.

Only one ‘PAUSE frame including the bandwidth information S213 stored therein’ is transmitted under the following conditions: when a PAUSE frame transmission request is received from the user setting terminal 26; when there is a change in the bandwidth information S213 set by the user setting terminal 26; and when an Ethernet link between the transmission-side communication apparatus 20 and the reception-side communication apparatus 21 is reestablished from a disconnected state.

### Received Data Determining Unit 2022

The received data determining unit 2022 determines whether the MAC frame received by the MAC frame receiving unit 202 is a ‘data frame’, the ‘PAUSE frame according to the related art’, or the ‘PAUSE frame including the bandwidth information S213 stored therein’ on the basis of a ‘DA field’, a ‘Length/Type field’, an ‘Opcode field’, and the ‘bandwidth control validity field’ of the ‘Padding field’ in the MAC frame. The term ‘PAUSE frame according to the related art’ means the PAUSE frame described with reference to FIG. 6.

When it is determined that the received MAC frame is the ‘data frame’, the received data determining unit 2022 forwards the data frame to the next processing unit (not shown) through S202. In addition, the received data determining unit 2022 sets transmission pause information S204 to ‘0’, and outputs the information to the MAC frame transmitting unit 201. However, the received data determining unit 2022 outputs no PAUSE bandwidth information S205.

Further, when it is determined that the received MAC frame is the ‘PAUSE frame according to the related art’, the received data determining unit 2022 performs the control process shown in FIG. 6.

That is, when it is determined that the received MAC frame is the ‘PAUSE frame according to the related art’, the received data determining unit 2022 sets the transmission pause information S204 to ‘1’, and outputs the information to the MAC frame transmitting unit 201. In addition, the received data determining unit 2022 outputs the value written in the ‘Pause Time field’ of the ‘PAUSE frame according to the related art’ to the MAC frame transmitting unit 201 as the PAUSE bandwidth information S205.

When it is determined that the received MAC frame is the ‘PAUSE frame including the bandwidth information S213 stored therein’, the received data determining unit 2022 sets the transmission pause information S204 to ‘1’, and outputs the information to the MAC frame transmitting unit 201. In addition, the received data determining unit 2022 outputs a value of ‘0’ written in the ‘Pause Time field’ of the ‘PAUSE frame including the bandwidth information S213 stored therein’ and the bandwidth information S213 to the MAC frame transmitting unit 201 as the PAUSE bandwidth information S205.

### Transmission Control Unit 2012

The transmission control unit 2012 determines whether to perform the PAUSE control process according to the related art shown in FIG. 6 or the bandwidth control process according to the exemplary embodiment, on the basis of the transmission pause information S204 and the PAUSE bandwidth information S205 received from the MAC frame receiving unit 202.

First, when the transmission pause information S204 includes a value of ‘0’, the transmission control unit 2012 outputs the MAC frame to the 10 Gbps transmission line 22 without performing a data transmission pause control process.

When the transmission pause information S204 including a value of ‘1’ is received from the MAC frame receiving unit 202, the transmission control unit 2012 checks the ‘bandwidth control validity field’ of the bandwidth information S213 included in the PAUSE bandwidth information S203. As the check result, when the value written in the ‘bandwidth control validity field’ is ‘0’, which indicates invalidity, the transmission control unit 2012 performs the data transmission pause control process according to the related art shown in FIG. 6. In this case, the transmission control unit 2012 stops the transmission of the MAC frame for a time that is obtained by multiplying the value written in the ‘Pause Time field’ included in the PAUSE bandwidth information S205 by a 512 bit time.

Further, when the value written in the ‘bandwidth control validity field’ is ‘1’, which indicates validity, the transmission control unit 2012 performs the data bandwidth control process according to the embodiment. In this case, the transmission control unit 2012 controls the transmission interval of the MAC frames, on the basis of the value written in the ‘IFG information field’ in the ‘Padding field’ included in the PAUSE bandwidth information S205.

When the transmission pause information S204 including a value of ‘1’ is received from the MAC frame receiving unit 202, the transmission control unit 2012 checks the PAUSE bandwidth information S205. As the check result, when the bandwidth information S213 is not included in the PAUSE bandwidth information S205, the transmission control unit 2012 performs the data transmission pause control process according to the related art shown in FIG. 6. However, when the bandwidth information S213 is included in the PAUSE bandwidth information S205, the transmission control unit 2012 performs the data bandwidth control process according to the exemplary embodiment on the basis of the bandwidth information S213.

In the bandwidth control system according to the exemplary embodiment, when the bandwidth control process according to the exemplary embodiment is performed, the reception-side communication apparatus 21 transmits, to the transmission-side communication apparatus 20, the ‘PAUSE frame’ including the bandwidth information S213 that can be received by the reception-side communication apparatus 21. Then, the transmission-side communication apparatus 20 controls the bandwidth of the MAC frame transmitted to the reception-side communication apparatus 21, on the basis of the bandwidth information S213 included in the ‘PAUSE frame’ received from the reception-side communication apparatus 21. In this way, the transmission-side communication apparatus 20 can check the bandwidth information S213 that can be received by the reception-side communication apparatus 21, and restrict the MAC frames transmitted to the reception-side communication apparatus 21. Therefore, it is possible to prevent the overload of the reception-side communication apparatus 21, unlike the PAUSE frame control process according to the related art shown in FIG. 6.

For example, in the PAUSE frame control process according to the related art shown in FIG. 6, when the amount of data stored in the MAC frame storage memory 2111 is larger than a predetermined threshold value, the reception-side communication apparatus 21 transmits the ‘PAUSE frame’ to the transmission-side communication apparatus 20. When the ‘PAUSE frame’ is received, the transmission-side communication apparatus 20 stops the transmission of the MAC frame to the reception-side communication apparatus 21.

Therefore, in the PAUSE frame control process according to the related art, even when the amount of data stored in the MAC frame storage memory 2111 of the transmission-side communication apparatus 21 is larger than the predetermined threshold value, the transmission-side communication apparatus 20 transmits the MAC frames to the reception-side communication apparatus 21 until the transmission-side communication apparatus 20 receives the ‘PAUSE frame’. As a result, memory resources of the MAC frame storage memory 2111 in the reception-side communication apparatus 21 are insufficient, which may cause the overload of the reception-side communication apparatus 21. In addition, in the PAUSE frame control process according to the related art, as the length of the 10 Gbps transmission line 24 increases, the time required to receive the ‘PAUSE frame’ is delayed. As a result, the above problem is remarkable.

In contrast, in the bandwidth control system according to the exemplary embodiment, the reception-side communication apparatus 21 transmits, to the transmission-side communication apparatus 20, the ‘PAUSE frame’ including the bandwidth information S213 that can be received by the reception-side communication apparatus 21 itself, and the transmission-side communication apparatus 20 controls the transmission interval of the MAC frames transmitted to the reception-side communication apparatus 21, on the basis of the bandwidth information 213 included in the ‘PAUSE frame’. In this way, it is possible to adjust the MAC frames stored in the MAC frame storage memory 2111, and thus prevent the overload of the reception-side communication apparatus 21.

Further, in the bandwidth control system according to the exemplary embodiment, since the reception-side communication apparatus 21 transmits, to the transmission-side communication apparatus 20, the ‘PAUSE frame’ including the bandwidth information S213 that can be received by the reception-side communication apparatus 21 itself, it is possible to limit the bandwidth of the MAC frames transmitted from the transmission-side communication apparatus 20 to the reception-side communication apparatus 21 to an arbitrary value beforehand. Therefore, it is possible to control the bandwidth of the MAC frame transmitted from the transmission-side communication apparatus 20 to the reception-side communication apparatus 21 to be constant, regardless of the lengths of the transmission lines 22 and 24 between the transmission-side communication apparatus 20 and the reception-side communication apparatus 21.

Furthermore, in the bandwidth control system according to the exemplary embodiment, the reception-side communication apparatus 21 transmits the ‘PAUSE frame’ including the bandwidth information S213 stored therein to the transmission-side communication apparatus 20 only one time, and the transmission-side communication apparatus 20 controls the MAC frame transmitted to the reception-side communication apparatus 21 on the basis of the bandwidth information S213 included in the ‘PAUSE frame’, which makes it possible to prevent the overload of the reception-side communication apparatus 21. As a result, the bandwidth control system according to the exemplary embodiment can effectively utilize the bandwidth of the transmission line 24 through which the reception-side communication apparatus 21 transmits the MAC frames to the transmission-side communication apparatus 20.

### Fourth Exemplary Embodiment

Next, a fourth exemplary embodiment of the invention will be described.

In the third exemplary embodiment, when it is determined that the bandwidth control according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ including IFG information set by the user setting terminal 26 stored therein, which are shown in FIG. 8.

In the fourth exemplary embodiment, the input bandwidth control unit 2113 compares the amount of data stored in the MAC frame storage memory 2111 with a predetermined threshold value. As the result of the comparison, when the amount of data stored in the MAC frame storage memory 2111 is larger than the predetermined threshold value, the input bandwidth control unit 2113 outputs, to the PAUSE frame transmitting unit 2123, the bandwidth information S213 including the IFG information set by the user setting terminal 26 stored in the ‘IFG information field’. When the amount of data stored in the MAC frame storage memory 2111 is not larger than the predetermined threshold value, the input bandwidth control unit 2113 outputs, to the PAUSE frame transmitting unit 2123, the bandwidth information S213 including the ‘IFG information field’ in which the IFG information including a value of 0 is written.

In this way, the bandwidth control system according to the exemplary embodiment can control the MAC frame transmitted to the reception-side communication apparatus 21 according to the empty state of memory resources of the MAC frame storage memory 2111 in the reception-side communication apparatus 21. As a result, it is possible to effectively utilize network resources. The fourth exemplary embodiment will be described in detail below.

### Structure of Bandwidth Control System

First, the structure of the bandwidth control system according to the exemplary embodiment will be described with reference to FIG. 7.

The structure of the bandwidth control system according to the fourth exemplary embodiment is similar to that according to the third exemplary embodiment except for the control operation of the input bandwidth control unit 2113 in the reception-side communication apparatus 21. The control operation of the input bandwidth control unit 2113 will be described in detail below.

### Input Bandwidth Control Unit 2113

In the fourth exemplary embodiment, when receiving storage data amount information S211 transmitted from the MAC frame storage memory 2111, the input bandwidth control unit 2113 compares the amount of data stored in the MAC frame storage memory 2111 with a predetermined threshold value, on the basis of the received storage data amount information S211. When the amount of data stored in the MAC frame storage memory 2111 is larger than the predetermined threshold value, the input bandwidth control unit 2113 determines whether a bandwidth control process according to the exemplary embodiment is set to be valid or invalid. When it is determined that the bandwidth control process according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ including IFG information set by the user setting unit 26 stored therein, which are shown in FIG. 8.

In this way, when it is determined that the amount of data stored in the MAC frame storage memory 2111 is larger than the predetermined threshold value and the bandwidth control process according to the exemplary embodiment is set to be valid, the input bandwidth control unit 2113 can control the bandwidth of the MAC frame such that the reception-side communication apparatus 21 can receive the MAC frame.

Further, when it is determined that the amount of data stored in the MAC frame storage memory 2111 is larger than the predetermined threshold value and the bandwidth control process according to the exemplary embodiment is set to be invalid, the input bandwidth control unit 2113 outputs, to the PAUSE frame transmitting unit 2123, the bandwidth information S213 including the ‘bandwidth control validity field’ including a value ‘0’ written therein, which is shown in FIG. 8.

In this way, when it is determined that the amount of data stored in the MAC frame storage memory 2111 is larger than the predetermined threshold value and the bandwidth control process according to the exemplary embodiment is set to be invalid, the input bandwidth control unit 2113 can perform the bandwidth control process according to the related art shown in FIG. 6.

Furthermore, when it is determined that the amount of data stored in the MAC frame storage memory 2111 is not larger than the predetermined threshold value and the bandwidth control process according to the exemplary embodiment is set to be valid, the input bandwidth control unit 2113 outputs, to the PAUSE frame transmitting unit 2123, the bandwidth information S213 including the ‘bandwidth control validity field’ including a value of ‘1’ written therein and the ‘IFG information field’ in which IFG information including a value of 0 is written, which are shown in FIG. 8.

In this way, when it is determined that the amount of data stored in the MAC frame storage memory 2111 is not larger than the predetermined threshold value and the bandwidth control process according to the exemplary embodiment is set to be valid, the input bandwidth control unit 2113 can remove the limitations in the bandwidth of the MAC frame that can be received by the reception-side communication apparatus 21.

Further, in the embodiment, the input bandwidth control unit 2113 controls the PAUSE transmission information S212 output to the selector 2122, and controls the selector 2122 to transmit only one ‘PAUSE frame’ including the bandwidth information S213 including the ‘IFG information field’ in which IFG information including a value of ‘0’ is written.

That is, in the exemplary embodiment, the input bandwidth control unit 2113 controls the selector 2122 to transmit the ‘PAUSE frame’ including the bandwidth information S213 including the ‘IFG information field’ in which IFG information including a value of ‘0’ is written. Therefore, when it is determined that the amount of data stored in the MAC frame storage memory 2111 is not larger than the predetermined threshold value once, the input bandwidth control unit 2113 sets the value of the PAUSE transmission information S212 to ‘1’, and outputs the information to the selector 2122. Then, the input bandwidth control unit 2113 controls the selector 2122 to transmit the ‘PAUSE frame’ including the bandwidth information S213 including the ‘IFG information field’ in which IFG information including a value of ‘0’ is written.

When it is determined that the amount of data stored in the MAC frame storage memory 2111 is not larger than the predetermined threshold value two or more times, the input bandwidth control unit 2113 sets the value of the PAUSE transmission information S212 to ‘0’, and outputs the information to the selector 2122. Then, the input bandwidth control unit 2113 controls the selector 2122 to transmit the ‘MAC data frame’.

As described above, the reception-side communication apparatus 21 according to the embodiment can control the MAC frames transmitted to the reception-side communication apparatus 21 according to the empty state of memory resources of the MAC frame storage memory 2111 in the reception-side communication apparatus 21. As a result, it is possible to effectively utilize network resources.

Although the preferred exemplary embodiments of the invention have been described above, the invention is not limited thereto. Various modifications and changes of the invention can be made without departing from the scope and spirit of the invention.

For example, in the bandwidth control systems according to the above-described exemplary embodiments, the bandwidth information S213 is set by the user setting terminal 26, but the invention is not limited thereto. The reception-side communication apparatus 21 may monitor the data bandwidth of the transmission line 23, and set the data bandwidth of the transmission line 23 on the basis of the bandwidth information S213, when the data bandwidth of the transmission line 23 is changed. In this case, the reception-side communication apparatus 21 compares the data bandwidth of the transmission line 22 with the data bandwidth of the transmission line 23. As the result of the comparison, when the data bandwidth of the transmission line 23 is smaller than that of transmission line 22, the data bandwidth of the transmission line 23 is set on the basis of the bandwidth information S213, and the ‘PAUSE frame reception-side communication apparatus 21 including the set bandwidth information S213 is transmitted to the transmission-side communication apparatus 20.

Further, the control operations of the communication apparatuses 20 and 21, such as the transmission-side communication apparatus 20 and the reception-side communication apparatus 21 according to the above-described exemplary embodiments, may be executed by software, such as computer programs, not by hardware components. In addition, the programs may be stored in recording media, such as optical recording media, magnetic recording media, magneto-optical recording media, and semiconductors, and the communication apparatuses 20 and 21 may read the programs from the recording medium and execute the programs to perform the control operations. Alternatively, the communication apparatuses 20 and 21 may read the programs from an external apparatus through a predetermined network, and execute the control operations.

Furthermore, the invention can be applied to communication apparatuses that transmit data frames and control frames through the same channel.

What is claimed is:

1. A bandwidth control apparatus comprising:
a transmitting unit that transmits, to a communication apparatus, a control frame including bandwidth information for controlling the bandwidth of data frames transmitted from the communication apparatus.

2. The bandwidth control apparatus according to claim 1, wherein the transmitting unit transmits the control frame including the bandwidth information in at least one of the following cases: a request to transmit the control frame including the bandwidth information is received; there is a variation in the bandwidth information; a communication link between the communication apparatus and the bandwidth control apparatus is reestablished from a disconnected state; and the bandwidth of data that can be output from the bandwidth control apparatus is smaller than that of data input from the communication apparatus to the bandwidth control apparatus.

3. The bandwidth control apparatus according to claim 1 further comprising:
a setting unit that sets whether to validate or invalidate a control process by the control frame including the bandwidth information,
wherein, when it is determined that the control process is set to be valid, the transmitting unit transmits the control frame including the bandwidth information to the communication apparatus, and
when it is determined that the control process is set to be invalid, the transmitting unit transmits a control frame without the bandwidth information to the communication apparatus.

4. The bandwidth control apparatus according to claim 3, further comprising:
a determining unit that determines whether an overload occurs in the bandwidth control apparatus,
wherein, when it is determined that the overload occurs and the control process is set to be valid, the transmitting unit transmits the control frame including the bandwidth information to the communication apparatus,
when it is determined that the overload occurs and the control process is set to be invalid, the transmitting unit transmits the control frame without the bandwidth information to the communication apparatus, and
when it is determined that the overload does not occur and the control process is set to be valid, the transmitting unit transmits the control frame including the bandwidth information including a value of ‘0’ to the communication apparatus.

5. A bandwidth control apparatus comprising:
a control unit that, when a control frame including bandwidth information is received, controls the transmission of data frames on the basis of the bandwidth information included in the control frame.

6. The bandwidth control apparatus according to claim 5,
wherein, when a control frame without the bandwidth information is received, the control unit controls the transmission of the data frames on the basis of the control frame.

7. A bandwidth control system comprising:
a transmission-side communication apparatus that transmits data frames; and
a reception-side communication apparatus that receives the data frames,
wherein the reception-side communication apparatus includes:
a transmitting unit that transmits, to the transmission-side communication apparatus, a control frame including bandwidth information for controlling the bandwidth of the data frames transmitted from the transmission-side communication apparatus, and
the transmission-side communication apparatus includes:
a control unit that, when the control frame including the bandwidth information is received, controls the transmission of the data frames on the basis of the bandwidth information included in the control frame.

8. The bandwidth control system according to claim 7,
wherein the transmitting unit transmits the control frame including the bandwidth information in at least one of the following cases: a request to transmit the control frame including the bandwidth information is received; there is a variation in the bandwidth information; a communication link between the transmission-side communication apparatus and the reception-side communication apparatus is reestablished from a disconnected state; and the bandwidth of data that can be output from the reception-side communication apparatus is smaller than that of data input from the transmission-side communication apparatus to the reception-side communication apparatus.

9. The bandwidth control system according to claim 7, wherein the reception-side communication apparatus further includes:
a setting unit that sets whether to validate or invalidate a control process by the control frame including the bandwidth information,
when it is determined that the control process is set to be valid, the transmitting unit transmits the control frame including the bandwidth information to the transmission-side communication apparatus,
when it is determined that the control process is set to be invalid, the transmitting unit transmits a control frame without the bandwidth information to the transmission-side communication apparatus,
when the control frame including the bandwidth information is received, the control unit controls the transmission of the data frames on the basis of the bandwidth information included in the control frame, and
when the control frame without the bandwidth information is received, the control unit controls the transmission of the data frames on the basis of the control frame.

10. The bandwidth control system according to claim 9,
wherein the reception-side communication apparatus further includes:
a determining unit that determines whether an overload occurs in the reception-side communication apparatus,
when it is determined that the overload occurs and the control process is set to be valid, the transmitting unit transmits the control frame including the bandwidth information to the transmission-side communication apparatus,
when it is determined that the overload occurs and the control process is set to be invalid, the transmitting unit transmits the control frame without the bandwidth information to the transmission-side communication apparatus,
when it is determined that the overload does not occur and the control process is set to be valid, the transmitting unit transmits the control frame including the bandwidth information including a value of ‘0’ to the transmission-side communication apparatus, and
when the control frame including the bandwidth information including a value of ‘0’ is received, the control unit controls the transmission of the data frames on the basis of the bandwidth information including a value of ‘0’ included in the control frame.

11. The bandwidth control system according to claim 7
wherein the transmitting unit transmits the control frame including the bandwidth information to the transmission-side communication apparatus only one time.

12. The bandwidth control system according to claim 7,
wherein the reception-side communication apparatus further includes a setting unit that sets the bandwidth information.

13. The bandwidth control system according to claim 7,
wherein the control frame is a PAUSE frame,
the transmitting unit transmits the PAUSE frame including the bandwidth information to the transmission-side communication apparatus, and
the control unit controls the transmission of the data frames on the basis of the bandwidth information included in the PAUSE frame.

14. A bandwidth control method that is performed in a bandwidth control system including a transmission-side communication apparatus that transmits data frames and a reception-side communication apparatus that receives the data frames, the method comprising:
a transmission step of allowing the reception-side communication apparatus to transmit, to the transmission-side communication apparatus, a control frame including bandwidth information for controlling the bandwidth of the data frames transmitted from the transmission-side communication apparatus; and
a control step of allowing the transmission-side communication apparatus to, when the control frame including the bandwidth information is received, to control the transmission of the data frames on the basis of the bandwidth information included in the control frame.

15. The bandwidth control method according to claim 14,
wherein the transmission step transmits the control frame including the bandwidth information in at least one of the following cases: a request to transmit the control frame including the bandwidth information is received; there is a variation in the bandwidth information; a communication link between the transmission-side communication apparatus and the reception-side communication apparatus is reestablished from a disconnected state; and the bandwidth of data that can be output from the reception-side communication apparatus is smaller than that of data input from the transmission-side communication apparatus to the reception-side communication apparatus.

16. The bandwidth control method according to claim 14 further comprising:
a setting step of allowing the reception-side communication apparatus to set whether to validate or invalidate a control process by the control frame including the bandwidth information,
wherein, in the transmission step, when it is determined that the control process is set to be valid, the control frame including the bandwidth information is transmitted to the transmission-side communication apparatus,
when it is determined that the control process is set to be invalid, a control frame without the bandwidth information is transmitted to the transmission-side communication apparatus,
in the control step, when the control frame including the bandwidth information is received, the transmission of the data frames is controlled on the basis of the bandwidth information included in the control frame, and
when the control frame without the bandwidth information is received, the transmission of the data frames is controlled on the basis of the control frame.

17. The bandwidth control method according to claim 16, further comprising:
a determining step of determining whether an overload occurs in the reception-side communication apparatus,
wherein, in the transmission step, when it is determined that the overload occurs and the control process is set to be valid, the control frame including the bandwidth information is transmitted to the transmission-side communication apparatus,
when it is determined that the overload occurs and the control process is set to be invalid, the control frame without the bandwidth information is transmitted to the transmission-side communication apparatus,
when it is determined that the overload does not occur and the control process is set to be valid, the control frame including the bandwidth information including a value of ‘0’ is transmitted to the transmission-side communication apparatus, and
in the control step, when the control frame including the bandwidth information including a value of ‘0’ is received, the transmission of the data frames is controlled on the basis of the bandwidth information including a value of ‘0’ included in the control frame.

18. A bandwidth control method that is performed in a bandwidth control apparatus that transmits a control frame to a communication apparatus, the method comprising:
a transmission step of transmitting the control frame including bandwidth information for controlling the bandwidth of data frames transmitted from the communication apparatus.

19. The bandwidth control method according to claim 18,
wherein the transmission step transmits the control frame including the bandwidth information in at least one of the following cases: a request to transmit the control frame including the bandwidth information is received; there is a variation in the bandwidth information; a communication link between the communication apparatus and the bandwidth control apparatus is reestablished from a disconnected state; and the bandwidth of data that can be output from the bandwidth control apparatus is smaller than that of data input from the communication apparatus to the bandwidth control apparatus.

20. The bandwidth control method according to claim 18 further comprising:
a setting step of setting whether to validate or invalidate a control process by the control frame including the bandwidth information,
wherein, in the transmission step, when it is determined that the control process is set to be valid, the control frame including the bandwidth information is transmitted to the communication apparatus, and
when it is determined that the control process is set to be invalid, a control frame without the bandwidth information is transmitted to the communication apparatus.

21. The bandwidth control method according to claim 20, further comprising:
a determining step of determining whether an overload occurs in the bandwidth control apparatus,
wherein, in the transmission step, when it is determined that the overload occurs and the control process is set to be valid, the control frame including the bandwidth information is transmitted to the communication apparatus,
when it is determined that the overload occurs and the control process is set to be invalid, the control frame without the bandwidth information is transmitted to the communication apparatus, and
when it is determined that the overload does not occur and the control process is set to be valid, the control frame including the bandwidth information including a value of ‘0’ is transmitted to the communication apparatus.
